(19) United States
(12) Patent Application Publication
(10) Pub. No.: US 2022/0296466 A1
(43) Pub. Date: Sep. 22, 2022

(54) Stimulating acupuncture meridians through touching images on a smart phone with imprinted acupuncture meridian endogenous frequencies.

(71) Applicant: James Christopher Hubbard, Alexandria, VA (US)

(72) Inventor: James Christopher Hubbard, Alexandria, VA (US)

(21) Appl. No.: 17/301,023

(22) Filed: Mar. 22, 2021

(51) Int. Cl. A61H 39/02

(52) U.S. Cl. CPC A61H 39/02; A61H 2201/5007; A61H 2201/1635; A61H 2201/5043

(57) ABSTRACT

The invention allows the imprinting or stimulating of acupuncture meridians for 5 to 10 minutes through touching, with an index finger for 30 seconds to 2 minutes, a displayed image on a smartphone of reflected scattered light modulated by a magnetic field at the acupuncture meridian endogenous frequencies. The image of reflected scattered light modulated by acupuncture endogenous frequencies can be photographed by a smartphone digital camera on a white card adjacent to a low frequency voice coil with the endogenous frequencies energizing the coil.

### CROSS-REFERENCE TO RELATED APPLICATIONS

The invention was not publicly used anywhere in the world.
The invention was not offered for sale anywhere in the world.
The invention was not patented anywhere in the world.
The invention was not described in a printed publication or was available to the public anywhere in the world.

### STATEMENT REGARDING FEDERALLY SPONSORED RESEARCH OR DEVELOPMENT (IF APPLICABLE)

The invention was not made under a contract with an agency of the U.S. Government.

### BACKGROUND OF THE INVENTION

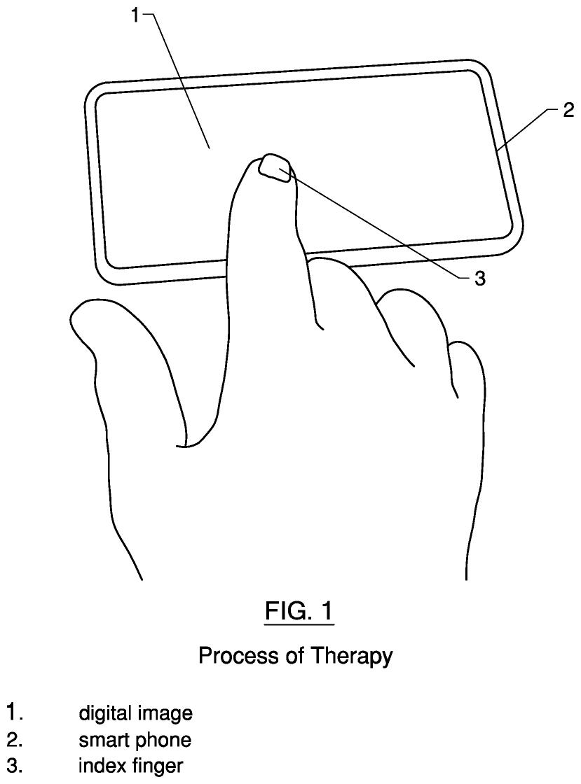

This invention is one of method or process. Today acupuncture therapy may involve the involvement of an acupuncture therapist, time to go to him/her, fee for services and scheduling. The acupuncturist would put needles into various acupuncture points along a specific meridian to stimulate the meridian and unblock the Qi—flow of energy—through the meridian for a healthier functioning system. Acupuncture has been approved by the NIH as a medical therapy for decades. When an acupuncture point is stimulated it stimulates the endogenous frequency of that meridian to spread all over the acupuncture meridian system of the body for a period of time thus unblocking meridians. An alternate therapy, acupressure, is to use pressure on acupuncture points to stimulate the points and the meridian—this requires extensive technical experience and knowledge to do this properly and it is less effective than acupuncture. This invention makes acupuncture therapy accessible on a smart phone wherever one is, whenever one needs it and therapy as much as needed, inexpensively through touching images with specific acupuncture meridian endogenous frequencies imprinted in them as can be seen in FIG. 1.

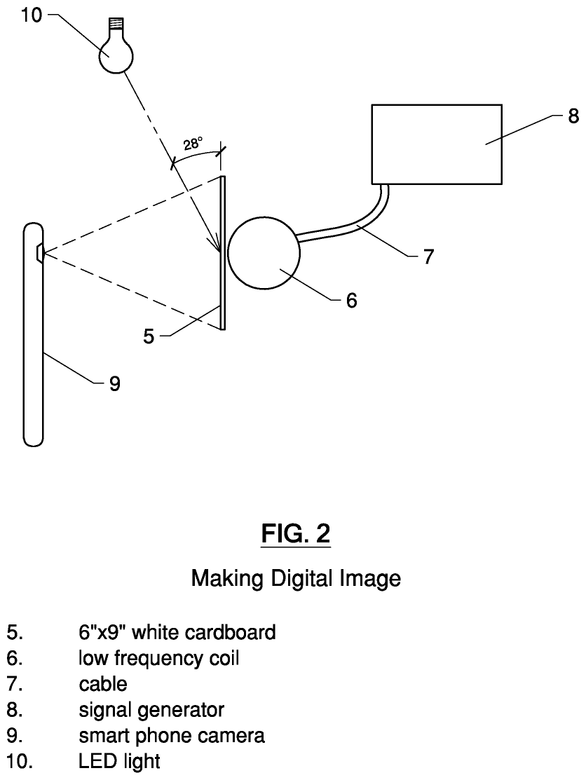

There has been imprinting of frequencies in tubes of water with a coil which one would hold to imprint on the acupuncture meridian system but this is cumbersome carrying around tudes of water. FIG. 2 shows the production of digital images with acupuncture meridian endogenous frequencies imprinted on it. To my knowledge this process has not been used before for this use.

### BRIEF SUMMARY OF THE INVENTION

This invention brings acupuncture therapy—stimulation of acupuncture meridians—to the user conveniently, inexpensively, without an acupuncturist and related fee and logistics, with little technical knowledge to the user through touching a smartphone image. Looking at FIG. 1 one can see the digital image with acupuncture meridian endogenous frequencies imprinted in it 1, the smart phone displaying it 2 and touching the image with an index finger for 30 seconds to 2 minutes 3. This touching stimulates acupuncture meridians for 5 to 10+ minutes all over the acupuncture meridian system with this particular meridian endogenous frequency. This can be repeated as needed.

The creation of the digital images with acupuncture meridian endogenous frequencies imprinted in it is depicted in FIG. 2.

### BRIEF DESCRIPTION OF THE SEVERAL VIEWS OF THE DRAWING

In FIG. 1 we see the process of the stimulation of the acupuncture meridian endogenous frequencies: one can see the digital image with acupuncture meridian endogenous frequencies imprinted in it 1, the smart phone displaying it 2 and touching the image with an index finger for 30 seconds to 2 minutes 3.

The creation of the digital images with acupuncture meridian endogenous frequencies imprinted in it is depicted in FIG. 2. The smart phone 9, photographs card 5 illuminated by LEDs 10 in front of coil 6 connected by cable 7 to signal generator 8 which is generating specific frequencies.

### DETAILED DESCRIPTION OF THE INVENTION

For the process in FIG. 1 we see the process of imprinting acupuncture meridian endogenous frequencies: one can see the digital image with acupuncture meridian endogenous frequencies imprinted in it 1, the smart phone displaying it 2 and touching the image with an index finger for 30 seconds to 2 minutes 3. There was a process of imprinting/stimulation of the acupuncture meridian endogenous frequencies in the literature through holding a tube of water with frequencies imprinted in it but the tubes are too cumbersome. There was also a process of imprinting frequencies into a tube of water by scattered light in the literature but not imprinting frequencies directly into the acupuncture meridian system through a finger by reflected scattered light.

The creation of the digital images with acupuncture meridian endogenous frequencies imprinted in it is depicted in FIG. 2. The smart phone 9 with camera, photographs white card, filling the frame, illuminated by LEDs at 28 degrees+with about 320 LUX on it 10 vertically against a 4″ woofer voice coil 6 connected by cable 7 to signal generator at about 0.5 Volt 8 which is generating specific acupuncture meridian endogenous frequencies. In literature, there was a process of imprinting frequencies into a tube of water through reflected scattered light from an image with frequencies imprinted but not imprinting frequencies directly into a finger into the acupuncture meridian system. The inventor performed experiments establishing that endogenous acupuncture meridian frequencies could be imprinted into an acupuncture meridian system through a digital image of reflected scattered light modulated by a magnetic field of those frequencies. Reflected scattered light modulated by a magnetic field of various frequencies can imprint those frequencies into blank water or the acupuncture meridian system of a human being through a finger at close proximity. These digital images with acupuncture meridian endogenous frequencies imprinted in them would be available for purchase. Each acupuncture meridian has a unique Extremely low frequency endogenous frequency from 0.00055 Hz to

[symbol]

1: Imprinting or stimulating acupuncture meridians with endogenous meridian frequencies for 5 to 10 minutes through touching images displayed on a smartphone for 30 seconds to 2 minutes with imprinted acupuncture meridian endogenous frequencies through reflected scattered light.

2: Digital images with imprinted acupuncture meridian endogenous frequencies through reelected scattered modulated light can be produced by photographing a white card with the reflected scattered light modulated by a magnetic field at these frequencies.

3: Reflected scattered light modulated by a magnetic field at a frequency or an digital image of such at these frequencies can imprint these frequencies into the acupuncture meridian system of a person through a finger in close proximity of the scattered light or displayed scattered light for a period of time.
